(19) United States
(12) Patent Application Publication
(10) Pub. No.: US 2014/0141174 A1
(43) Pub. Date: May 22, 2014

(54) METHOD OF MANUFACTURING A THERMAL BARRIER COATED ARTICLE

(71) Applicant: ROLLS-ROYCE PLC, (US)

(72) Inventors: Ian Murray GARRY, Thurcaston (GB); Michael Lawrence CARLISLE, Derby (GB)

(73) Assignee: ROLLS-ROYCE PLC, London (GB)

(21) Appl. No.: 13/799,740

(22) Filed: Mar. 13, 2013

(30) Foreign Application Priority Data
Mar. 22, 2012 (GB) 1205020.9

(51) Int. Cl. B05D 3/12; B05D 1/08

(52) U.S. Cl. CPC B05D 3/12; B05D 1/08
USPC 427/448; 427/271; 427/264

(57) ABSTRACT

A method of manufacturing a thermal barrier coated article including: forming an article having a first and second surface, the article having projections extending from the first surface away from the first and second surface, each projection having a first end adjacent the first surface and a second end remote from the first surface, each projection having a blind passage extending therethrough from the second surface through the article towards the second end of the projection, the blind passage in the projection being closed at the second end of the projection, depositing a thermal barrier coating on the first surface around each of the projections and on the second ends, removing the thermal barrier coating from the second ends, and removing the second end of each projection to form a passage through the projection extending from the second surface through the article to the second end of the projection.

The present invention relates to a method of manufacturing a thermal barrier coated article and in particular relates to a thermal barrier coated combustor tile, a thermal barrier coated turbine blade or a thermal barrier coated turbine vane.

Combustor tiles are provided with thermal barrier coatings to enable the combustor tiles to operate at higher temperatures. Combustor tiles are provided with effusion apertures to provide a film of coolant on the surface of the combustor tiles to also enable the combustor tiles to operate at higher temperatures.

Effusion apertures are conventionally produced in combustor tiles by laser machining, electro-discharge machining or electro-chemical machining.

Combustor tiles provided with thermal barrier coatings and effusion apertures suffer from problems.

If the thermal barrier coating is deposited on the combustor tile before the effusion aperture are produced in the combustor tile then the high energy associated with the laser machining, drilling, of the effusion apertures can result in the delamination of the thermal barrier coating from the combustor tile, If the laser machining, drilling, is performed at a much lower energy to avoid delamination of the thermal barrier coating then this is not suitable for mass production because of the increased time and cost of producing the effusion apertures.

If the thermal barrier coating is deposited on the combustor tile before the effusion aperture are produced in the combustor tile then it is not possible to electro-discharge machine, or electro-chemically machine, effusion apertures through a ceramic thermal barrier coating of a thermal barrier coating because the ceramic thermal barrier coating is not electrically conductive.

If the effusion apertures are produced in the combustor tile before the thermal barrier coating is deposited on the combustor tile then the deposition of the thermal barrier coating can result in partial or full blockage of the effusion apertures. A blockage in an effusion aperture is not acceptable because it reduces the flow of coolant and results in local overheating of the combustor tile.

It is known from U.S. Pat. No. 4,743,462, U.S. Pat. No. 6,335,078, EP1245691A2, US20040048003A1 and DE102006029071A1 to provide masks within the effusion apertures to prevent blockage of the effusion apertures during deposition of the thermal barrier coating. The masks are subsequently removed. However, this increases the manufacturing time and cost of producing the effusion apertures due to the extra processes.

It is known from U.S. Pat. No. 6,004,620 and US20110076405A1 to remove blockages from the effusion apertures after the thermal barrier coating has been deposited. However, this increases the manufacturing time and cost of producing the effusion apertures due to the extra processes.

The present invention seeks to provide a novel method of manufacturing a coated thermal barrier article which reduces, preferably overcomes, the above mentioned problems.

The present invention provides a method of manufacturing a thermal barrier coated article comprising the steps of:
a) forming an article having a first surface and a second surface, the article having at least one projection extending from the first surface in a direction away from the first surface and away from the second surface, the at least one projection having a first end adjacent the first surface and a second end remote from the first surface, the at least one projection having at least one blind passage extending through the at least one projection extending from the second surface of the article through the article and through the at least one projection towards the second end of the at least one projection, the at least one blind passage in the at least one projection being closed at the second end of the at least one projection,
b) depositing a thermal barrier coating on the first surface of the article around the at least one projection and on the second end of the at least one projection,
c) removing the thermal barrier coating from the second end of the at least one projection, and
d) removing the second end of the at least one projection to form at least one passage through the at least one projection extending from the second surface of the article through the article and through the at least one projection to the second end of the at least one projection.

Step a) may comprise forming an article having a plurality of projections extending from the first surface in a direction away from the first surface and away from the second surface, each projection having a first end adjacent the first surface and a second end remote from the first surface, each projection having at least one blind passage extending through the respective projection extending from the second surface of the article through the article and through the respective projection towards the second end of the respective projection, the at least one blind passage in the respective projection being closed at the second end of the respective projection, step b) may comprise depositing a thermal barrier coating on the first surface of the article around each projection and on the second end of each projection, step c) may comprise removing the thermal barrier coating from the second end of each projection, and step d) may comprise removing the second end of each projection to form at least one passage through each projection extending from the second surface of the article through the article and through the respective projection to the second end of the respective projection.

The second end of the at least one projection may be arranged at a first distance from the first surface of the article and the thermal barrier coating has a first thickness.

The first distance may be equal to or greater than the first thickness.

Step b) may comprise depositing a metallic bond coating on the first surface of the article and depositing a ceramic thermal barrier coating on the metallic bond coating.

The metallic bond coating may comprise a MCrAlY coating or an aluminide coating, where M is one or more of Ni, Co and Fe.

The ceramic thermal barrier coating may comprise stabilised zirconia.

The ceramic thermal barrier coating may comprise yttria stabilised zirconia.

The article may be a combustor tile, a turbine blade or a turbine vane.

Step a) may comprise forming the article and the at least one projection by casting.

Step a) may comprise forming the article and the at least one projection by direct laser deposition.

Step c) may comprise machining. Step d) may comprise machining. The machining may comprise finishing.

Step b) may comprise depositing the metallic bond coating by plasma spraying, thermal spraying or HVOF.

Step b) may comprise depositing the ceramic thermal barrier coating by plasma spraying, thermal spraying or HVOF.

The present invention will be more fully described with reference to the accompanying drawings, in which:

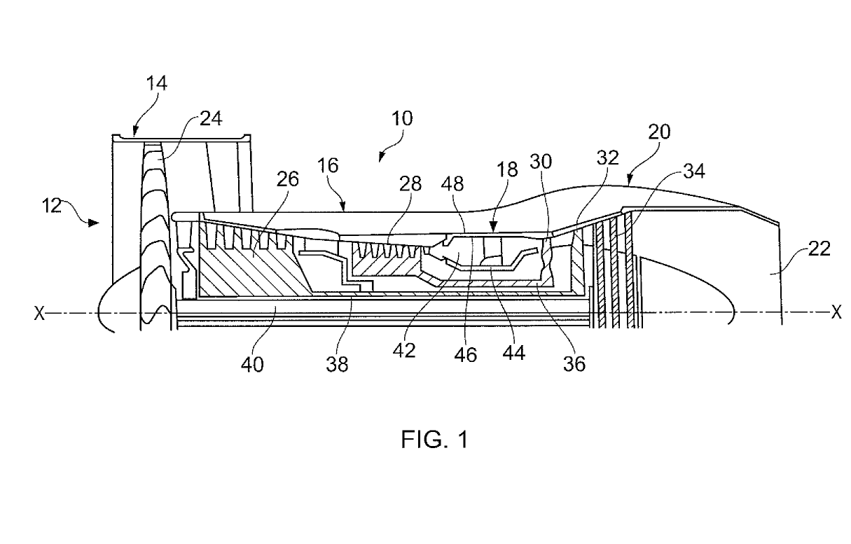

FIG. 1 is a cross-sectional view through a turbofan gas turbine engine having a combustion chamber according to the present invention.

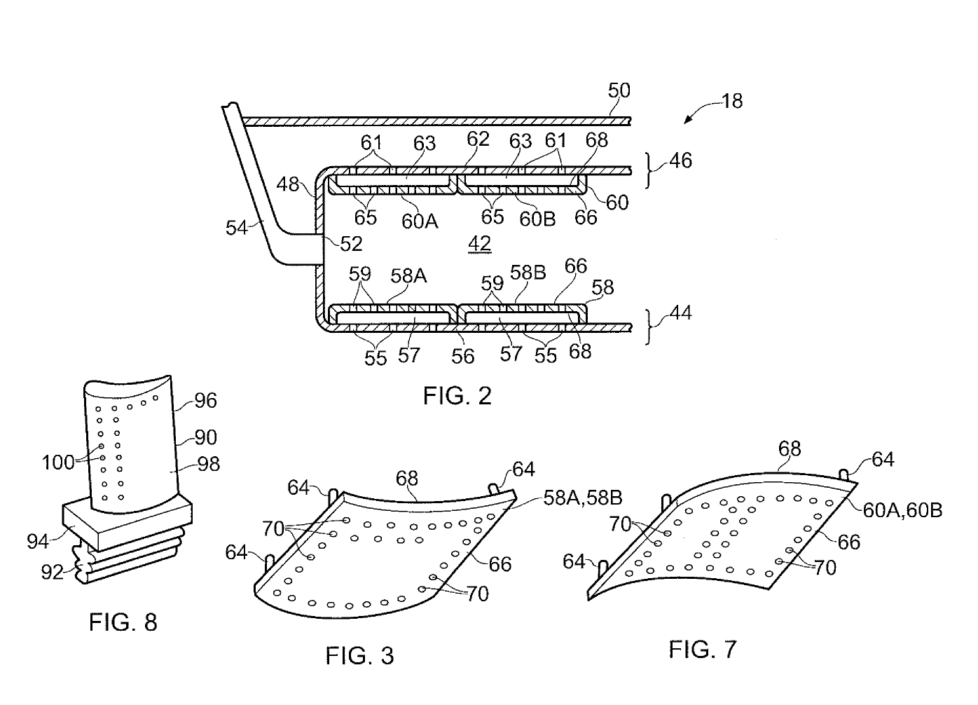

FIG. 2 is an enlarged cross-sectional view through the combustion chamber shown in FIG. 1.

FIG. 3 is a perspective view of a tile used in the combustion chamber shown in FIG. 2.

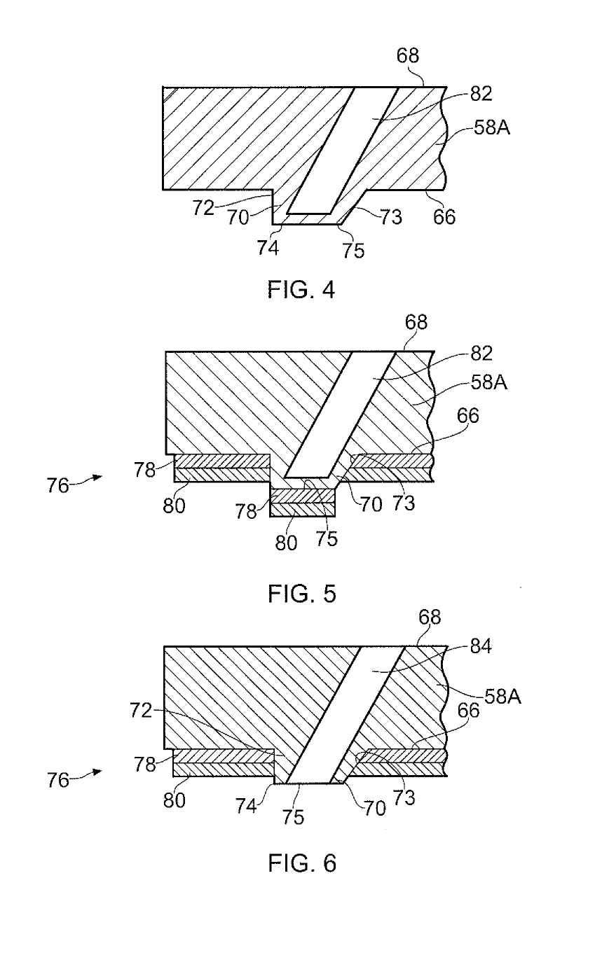

FIG. 4 is an enlarged cross-sectional view through a portion of the tile shown in FIG. 3 as initially manufactured.

FIG. 5 is an enlarged cross-sectional view through the portion of the tile shown in FIG. 3 after deposition of a thermal barrier coating.

FIG. 6 is an enlarged cross-sectional view through the portion of the tile shown in FIG. 3 after removal of the thermal barrier coating.

FIG. 7 is a perspective view of a further tile used in the combustion chamber shown in FIG. 2.

FIG. 8 is a perspective view of a turbine aerofoil used in the turbine shown in FIG. 1.

A turbofan gas turbine engine 10, as shown in FIG. 1, comprises in flow series an inlet 12, a fan section 14, a compressor section 16, a combustion section 18, a turbine section 20 and an exhaust 22. The fan section 14 comprises a fan 24. The compressor section 16 comprises in flow series an intermediate pressure compressor 26 and a high pressure compressor 28. The turbine section 20 comprises in flow series a high pressure turbine 30, an intermediate pressure turbine 32 and a low pressure turbine 34. The fan 24 is driven by the low pressure turbine 34 via a shaft 40. The intermediate pressure compressor 26 is driven by the intermediate pressure turbine 32 via a shaft 38 and the high pressure compressor 28 is driven by the high pressure turbine 30 via a shaft 36. The turbofan gas turbine engine 10 operates quite conventionally and its operation will not be discussed further. The turbofan gas turbine engine 10 has a rotational axis X.

The combustion section 18 comprises an annular combustion chamber 42, which is shown more clearly in FIG. 2. The annular combustion chamber 42 has a radially inner annular wall 44, a radially outer annular wall 46 and an upstream end wall 48 connecting the upstream ends of the radially inner annular wall 44 and the radially outer annular wall 46. The annular combustion chamber 42 is surrounded by a casing 50. The upstream end wall 48 has a plurality of circumferentially spaced fuel injector apertures 52 and each fuel injector aperture 52 has a respective one of a plurality of fuel injectors 54. The radially inner annular wall 44 is a double skin annular wall and the radially outer annular wall 46 is a double skin annular wall. The radially inner annular wall 44 comprises a radially inner wall 56 and a radially outer wall 58 and the radially outer annular wall 46 comprises a radially inner wall 60 and a radially outer wall 62.

The radially outer wall 58 of the radially inner annular wall 44 comprises a plurality of tiles 58A and 58B and the radially inner wall 60 of the radially outer annular wall 46 comprises a plurality of tiles 60A and 60B. The radially inner wall 56 has a plurality of apertures 55 to supply coolant, e.g. air, into the chamber, or chambers, 57 radially between the radially inner wall 56 and the tiles 58A and 58B of the radially outer wall 58 of the radially inner annular wall 44 and to provide impingement cooling of the surfaces 68 of the tiles 58A and 58B remote from the combustion chamber 42. The tiles 58A and 58B have effusion apertures 59 to supply the coolant, e.g. air, from the chamber, or chambers, 57 onto the surfaces 66 of the tiles 58A and 58B adjacent to the combustion chamber 42 to provide film cooling of those surfaces. The effusion apertures 59 extend through each tile 58A and 58B from the second surface 68 to the first surface 66 of the respective tile 58A and 58B. Similarly the radially outer wall 62 has a plurality of apertures 61 to supply coolant, e.g. air, into the chamber, or chambers, 63 radially between the radially outer wall 62 and the tiles 60A and 60B of the radially inner wall 60 of the radially outer annular wall 46 and to provide impingement cooling of the surfaces 68 of the tile 60A and 60B remote from the combustion chamber 42. The tiles 60A and 60B have effusion apertures 65 to supply the coolant, e.g. air, from the chamber, or chambers, 63 onto the surfaces 66 of the tiles 60A and 60B adjacent to the combustion chamber 42 to provide film cooling of those surfaces. The effusion apertures 65 extend through each tile 60A and 60B from the second surface 68 to the first surface 66 of the respective tile 60A and 60B.

One of the tiles 58A, 58B is shown more clearly in FIG. 3 and one of the tiles 60A, 60B is shown more clearly in FIG. 8. The tiles 58A, 58B, 60A, 60B are shown in the as manufactured condition, e.g. after casting or after forming by direct laser deposition. Each tile has a first surface 66 and a second surface 68. Each tile has a plurality of studs 64 secured to and extending away from the second surface 68. The studs 64 are used to fasten the tiles 58A and 58B to the radially inner wall 56 of the radially inner annular wall 44 and the studs 64 are used to fasten the tiles 60A and 60B to the radially outer wall 62 of the radially outer annular wall 46. It is to be noted that each tile has at least one projection 70, and preferably has a plurality of projections 70, secured to and extending from the first surface 66 in a direction away from the first surface 66 and away from the second surface 68. Each projection 70 has a first end 72 adjacent the first surface 66 and a second end 74 remote from the first surface 66. Each projection 70 is provided at a position on the respective tile where an effusion aperture, or passage, for coolant is required. Furthermore, each projection 70 has at least one blind passage 82 extending through the respective projection 70 and extending from the second surface 68 of the tile 58A through the tile 58A and through the respective projection 70 towards the second end 74 of the respective projection 70. The at least one blind passage 82 in the respective projection 70 is closed at the second end 74 of the respective projection 70. The tiles 58A, 58B, 60A, 60B are manufactured from a suitable metal or metal alloy for example an iron superalloy, a cobalt superalloy or preferably a nickel superalloy.

FIGS. 4 to 6 show steps in the manufacture of a thermal barrier coated tile 58A.

In particular FIG. 4 shows a portion of the tile 58A shown in FIG. 3 in the as manufactured condition after the first step of casting the tile or forming the tile by direct laser deposition. The tile 58A as mentioned previously is formed such that it has at least one projection 70 extending from the first surface 66 of the tile 58A. The tile 58A and the at least one projection 70 are formed integrally by casting or alternatively the tile 58A and the at least one projection 70 are formed integrally by direct laser deposition. The second end 74 of each projection 70 has a surface 75 which is arranged substantially parallel to the first surface 66 of the tile 58A and in this example each projection 70 has an angled side surface 73. The tile 58A has a plurality of blind passages 82 extending from the second surface 68 of the tile 58A through the tile 58A and through a respective projection 70 towards the second end 74 of the respective projection 70. Each blind passage 82 in the respective projection 70 is closed at the second end 74 of the respective projection 70. It is preferred that each projection 70 is produced in the tile by producing a recess at the corresponding position in the corresponding surface of the casting mould and each blind passage 82 is produced in the tile by providing a core, or projection, at the corresponding position in the corresponding surface of the casting mould and which extends from the casting mould so that all the projections and recesses are produced in the tile by the casting process. Alternatively each projection 70 is produced in the tile by producing a recess at the corresponding position in the corresponding surface of the casting mould during the casting process. After the casting process each blind passage 82 is produced in the finished tile by machining, drilling, a blind passage at the corresponding position in the tile.

FIG. 5 shows the portion of the tile 58A after a thermal barrier coating 76 has been deposited onto the first surface 66 of the tile 58A. The thermal barrier coating 76 is deposited onto the first surface 66 of the tile 58A by depositing a metallic bond coating 78 on the first surface 66 of the tile 58A and then by depositing a ceramic thermal barrier coating 80 on the metallic bond coating 78. It is to be noted that the thermal barrier coating 76 is deposited onto the first surface 66 of the tile 58A around each of the projections 70 and on the surface 75 at the second end 74 of each projection 70 and also on the angled side surface 73. The metallic bond coating 78 may comprise a MCrAlY coating or an aluminide coating, where M is one or more of Ni, Co and Fe, The aluminide coating may be a platinum-group metal aluminide, where the platinum-group metal is platinum, palladium, rhodium, iridium or osmium, a silicon aluminide coating, a chromium aluminide, or a combination of one two or more of these. The MCrAlY coating may be deposited by plasma spraying, thermal spraying or HVOF. The plasma spraying may be vacuum plasma spraying or air plasma spraying. The aluminide coating may be deposited by aluminising, by depositing a platinum-group metal and diffusion heat treating and then aluminising, by silicon aluminising, chrome aluminising etc. The ceramic thermal barrier coating 80 may comprise stabilised zirconia, for example the ceramic thermal barrier coating 80 may comprise yttria stabilised zirconia. However, other suitable ceramics may be used. The ceramic thermal barrier coating may be deposited by plasma spraying, thermal spraying or HVOF. The plasma spraying may be vacuum plasma spraying or air plasma spraying.

FIG. 6 shows the portion of the tile 58A after the thermal barrier coating 76 has been removed from the surface 75 at the second end 74 of each projection 70. The thermal barrier coating 76 may be removed from the surface 75 at the second end 74 of each projection 70 by machining, e.g. by linishing or automated linishing or other suitable machining process. It is not necessary to remove the thermal barrier coating 76 from the angled side surfaces 73 of the projections 70.

FIG. 6 also shows the portion of the tile 58A after effusion apertures, or passages, 84 have been formed through the tile 58A. Each effusion aperture, or passage, 84 extends from the second surface 68 of the tile 58A through the tile 58A and through the respective projection 70 to the surface 75 at the second end 74 of the respective projection 70. The tile 58A has a thermal barrier coating 76 on the first surface 66 around each of the projections 70. The effusion apertures 84 are formed by removing a sufficient amount of material from the second end 74 of each projection to form at least one effusion aperture, passage, 84 through the each projection 70 by uncovering or interconnecting with the blind aperture 82. The amount of material removed from the end of each projection 70 is the same as the thickness of the material between the end of the blind passage 82 and the surface 75 at the second end 74 of the projection. Each effusion aperture, passage, 84 extending from the second surface 68 of the tile 58A through the tile 58A and through the respective projection 70 to the second end 74 of the respective projection 70. The material is removed from the second end 74 of each projection 70 by machining, e.g. by linishing or automated linishing or other suitable machining process.

The surface 75 at the second end 74 of each projection 70 may be arranged at a first distance from the first surface 66 of the tile 58A and the thermal barrier coating 76 has a first thickness. The first distance may be equal to or greater than the first thickness. The second end 74 of each projection 70 is cooled by the coolant, air flowing through the respective effusion aperture 84 and this prevents burning or loss of metal from the second ends 74 of the projections 70.

FIG. 8 shows a turbine blade 90 which comprises a root portion 92, a platform portion 94 and an aerofoil portion 96. The aerofoil portion 96 is provided with a thermal barrier coating 98 on its outer surface and a plurality of effusion apertures, or passages, 100 extend through the aerofoil portion 96 of the turbine blade 90. The effusion apertures 100 are provided in projections extending from the outer surface of the aerofoil portion 96 of the turbine blade 90 and the thermal barrier coating 98 surrounds all of the projections in a similar manner to that described for the tiles of the combustion chamber with respect to FIGS. 2 to 6. The turbine blade 90 is manufactured from a suitable metal or metal alloy for example an iron superalloy, a cobalt superalloy or preferably a nickel superalloy, e.g. CMSX4, CMSX10 and is produced by casting. The turbine blade, or turbine vane, may be produced by directional solidification to produce a directionally solidified component, or to produce a single crystal component, or alternatively may be an equiaxed component.

As shown in FIGS. 4 to 6 the projections 70 are tapered at one side, they have an angled side surface 73, to allow the effusion apertures 82 to be arranged at an angle between 90° and 0° to the first surface 66 of the tile 58A. The projections 70 have a greater cross-sectional area at the first end 72 than the second end 74. However, it may be possible for the projections 70 to be cylindrical in the case of effusion apertures 84 arranged at 90° to the first surface 66 of the tile 58A. Other suitable shapes of projections 70 may be used, for example the projections 70 could be tapered on all sides, the angled side surface 73 extends all around the projection 70, such that they have a greater cross-sectional area at the first end 72 than at the second end 74, e.g. the projections 70 may be conical and decrease in diameter from the first end 72 to the second end 74.

For example the effusion apertures have a diameter of at least 0.5 mm and up to 1 mm and the projections have a diameter of at least 1 mm and up to 2 mm. The thermal barrier coating may have a thickness of up to 1 mm, the ceramic thermal barrier coating may have a thickness of up to 0.5 mm and the metallic bond coating may have thickness of up to 0.5 mm and the projections have a height, a first distance from the surface of the article, of at least the thickness of the thermal barrier coating, e.g. up to 1 mm.

The present invention provides a thermal barrier coated article, the article having a first surface and a second surface, the article having at least one projection extending from the first surface in a direction away from the first surface and away from the second surface, the projection having a first end adjacent the first surface and a second end remote from the first surface, the article having at least one passage extending from the second surface of the article through the article and through the at least one projection to the second end of the at least one projection and the article having a thermal barrier coating on the first surface around the at least one projection.

In a preferred embodiment of the present invention provides a thermal barrier coated article with a plurality of projections extending from the first surface in a direction away from the first surface and away from the second surface, each projection having a first end adjacent the first surface and a second end remote from the first surface, the article having a plurality of passages extending from the second surface of the article, each passage extending from the second surface of the article through the article and through a respective one of the projections to the second end of the respective projection and the article having a thermal barrier coating on the first surface around each of the projections.

The article may be a combustor tile, a turbine blade or a turbine vane for a gas turbine engine.

The advantage of the present invention is that it provides a positive feature, a projection, at each desired aperture position in the article which allows the thermal barrier coating to be removed from the projection thus revealing the metallic article at each desired aperture position. This allows the aperture to be formed through the projection and article by removing material from the end of the projection to uncover the blind aperture in the projection. The present invention provides an article with a robust thermal barrier coating with no delamination of the thermal barrier coating and un-blocked effusion apertures and the article can be produced in a production worthy cost effective method.

1. A method of manufacturing a thermal barrier coated article comprising the steps of:
a) forming an article having a first surface and a second surface, the article having at least one projection extending from the first surface in a direction away from the first surface and away from the second surface, the projection having a first end adjacent the first surface and a second end remote from the first surface, the at least one projection having at least one blind passage extending through the at least one projection extending from the second surface of the article through the article and through the at least one projection towards the second end of the at least one projection, the at least one blind passage in the at least one projection being closed at the second end of the at least one projection,
b) depositing a thermal barrier coating on the first surface of the article around the at least one projection and on the second end of the at least one projection,
c) removing the thermal barrier coating from the second end of the at least one projection, and
d) removing the second end of the at least one projection to form at least one passage through the at least one projection extending from the second surface of the article through the article and through the at least one projection to the second end of the at least one projection.

2. A method as claimed in claim 1 wherein step a) comprises forming an article having a plurality of projections extending from the first surface in a direction away from the first surface and away from the second surface, each projection having a first end adjacent the first surface and a second end remote from the first surface, each projection having at least one blind passage extending through the respective projection extending from the second surface of the article through the article and through the respective projection towards the second end of the respective projection, the at least one blind passage in the respective projection being closed at the second end of the respective projection, step b) comprises depositing a thermal barrier coating on the first surface of the article around each projection and on the second end of each projection, step c) comprises removing the thermal barrier coating from the second end of each projection, and step d) comprise removing the second end of each projection to form at least one passage through each projection extending from the second surface of the article through the article and through the respective projection to the second end of the respective projection.

3. A method as claimed in claim 1 wherein the second end of the at least one projection is arranged at a first distance from the first surface of the article and the thermal barrier coating has a first thickness.

4. A method as claimed in claim 3 wherein the first distance is equal to or greater than the first thickness.

5. A method as claimed in claim 1 wherein step b) comprises depositing a metallic bond coating on the first surface of the article and depositing a ceramic thermal barrier coating on the metallic bond coating.

6. A method as claimed in claim 5 wherein the metallic bond coating is selected from the group consisting of a MCrAlY coating and an aluminide coating, where M is one or more of Ni, Co and Fe.

7. A method as claimed in claim 5 wherein the ceramic thermal barrier coating comprises stabilised zirconia.

8. A method as claimed in claim 7 wherein the ceramic thermal barrier coating comprises yttria stabilised zirconia.

9. A method as claimed in claim 1 wherein the article is selected from the group consisting of a combustor tile, a turbine blade and a turbine vane.

10. A method as claimed in claim 1 wherein step a) comprises forming the article and the at least one projection by casting.

11. A method as claimed in claim 1 wherein step a) comprises forming the article and the at least one projection by direct laser deposition.

12. A method as claimed in claim 1 wherein step c) comprises machining.

13. A method as claimed in claim 1 wherein step d) comprises machining.

14. A method as claimed in claim 12 wherein the machining comprises linishing.

15. A method as claimed in claim 13 wherein the machining comprises linishing.

16. A method as claimed in claim 5 wherein step b) comprises depositing the metallic bond coating by a method selected from the group consisting of plasma spraying, thermal spraying and HVOF.

17. A method as claimed in claim 5 wherein step b) comprises depositing the ceramic thermal barrier coating by a method selected from the group consisting of plasma spraying, thermal spraying and HVOF.
